(19) United States
(12) Patent Application Publication
(10) Pub. No.: US 2013/0054475 A1
(43) Pub. Date: Feb. 28, 2013

(54) Method and Apparatus for Validating Time-Limited Warranty

(71) Applicant: Mark Cuddeback, Green Bay, WI (US)

(72) Inventor: Mark Cuddeback, Green Bay, WI (US)

(73) Assignee: NON TYPICAL, INC., Green Bay, WI (US)

(21) Appl. No.: 13/218,155

(22) Filed: Aug. 25, 2011

(51) Int. Cl. G06Q 10/00

(52) U.S. Cl. 705/302

(57) ABSTRACT

A method and apparatus for validating a time-limited warranty of a product warranted by a warrantor. The product preferably has a controller with a user interface operably connected to the controller. In the inventive method, warranty-pertinent information is permanently recorded with the controller. It is preferred that the warranty-pertinent information include a post-sale activation date and an automatically-counted number of run days since post-sale activation. The warranty-pertinent information is retrieved, and the post-sale period compared with the length of the time-limited warranty. Validity of a warranty claim is determined based on whether the recorded number of run days is consistent with the post-sale period.

### FIELD OF THE INVENTION

The invention relates to electronic products covered by time-limited manufacturer's warranty and, more particularly, to ways of verifying validity of warranty claims on such products.

### BACKGROUND OF THE INVENTION

It is most common that electronic devices, including image-recording cameras, be covered by manufacturer's warranty. However, retailers rarely record serial numbers of purchased products on sales receipts. And, some camera owners have used such lack of control in sales recording to submit fraudulent warranty claims. More specifically, after a purchase of a new camera, such people use the recent sales receipt to make a fraudulent warranty claim for an out-of-warranty failed camera. As a result, camera manufacturers suffer significant loses every year in honoring fraudulent warranty claims for products which have outlived their warranty periods. Therefore, there is a need for ways to confirm validity of warranty claims.

One example of such cameras are scouting cameras for scouting potential hunting areas and determining game patterns, particularly without disturbing animal activity. Typically, the apparatus includes a film, digital or video camera and a passive infrared sensor (e.g., a motion/heat sensor) that is adapted to sense movement and, in response, activate the camera focused on the area in which the sensor detects movement. Oftentimes, these devices include a delay timer with multiple settings to match specific conditions or locations, thus eliminating unwanted multiple exposures or other non-desired events.

Typical digital scouting cameras save images using known image file types. This allows users to view the images on their PCs using the image-viewing software installed on the PCs. The data storage media of typical digital scouting cameras is recognized by such PCs as being a computer drive or other ancillary computer device.

### OBJECTS OF THE INVENTION

It is an object of the invention to provide an improvement in providing warranty coverage that overcomes some of the problems and shortcomings of the prior art, including those referred to above.

Another object of the invention is to provide an improved validation of time-limited manufacturer's warranty of a product.

Another object of the invention is to provide an improved product allowing for validation of a time-limited warranty of the product.

Still another object of the invention is to provide an improved apparatus for validating a time-limited warranty of a warranted product.

How these and other objects are accomplished will become apparent from the following descriptions and the drawings.

### SUMMARY OF THE INVENTION

The present invention provides a method and apparatus for validating a time-limited warranty of a product warranted by a warrantor. The product preferably has a controller with a user interface operably connected to the controller. In the inventive method, warranty-pertinent information is permanently recorded with the controller. It is preferred that the warranty-pertinent information include a post-sale activation date and an automatically-counted number of run days since post-sale activation. The warranty-pertinent information is retrieved and the post-sale period is compared with the length of the time-limited warranty. Validity of a warranty claim is determined based on whether the recorded number of run days is consistent with the post-sale period. The consistency is preferably determined by the number of run days being no greater than the post-sale period. It should be understood that in some exceptional situations, such as when the number of run days is very low, but the time limit is outside of allowed warranty term, the warranty may still be honored. This is because the product failed without sufficient use, which indicates a flaw in the product justifying warranty replacement or compensation.

The warranty period may be changed to either one year from the first activation or to 180 run days. As a result, the customer does not need a sales receipt to make a warranty claim.

In preferred embodiments, the product is configured to record and store images. The inventive method further preferably includes the step of permanently recording a total number of images taken by the product.

The product may be a motion-activated camera. The product may also be a scouting camera for recording the presence of game.

The post-sale activation date and the number of run days may be recorded in data associated with each stored image. Such data may be viewed using Windows photo viewer's “Properties” command. The warrantor may also have a special software that displays this data in a user friendly format.

Alternatively, the warranty-pertinent information may be recorded in a product menu. The menu-stored data may be accessible either only by the manufacturer or by the manufacturer and the product user. It is highly preferred that the data is not alterable.

In some embodiments, the retrieving step is performed by the programmed controller.

The product is preferably configured to indicate warranty status. It is preferred that the warranty status is indicated upon each powering of the product.

In some embodiments, the retriever is warrantor-based. And, the retrieving includes steps taken by the warrantor using a retriever separate from the product. The retriever may be a computer programmed to perform the steps of determining the post-sale period of the product, comparing the post-sale period with the length of the time-limited warranty and determining whether the recorded number of run days is consistent with the post-sale period.

The retriever may include a visual display of the warranty-pertinent information. And, the retrieving step preferably includes a visual display of the warranty-pertinent information. It is preferred that the method further include the step of visually displaying warranty status. The step of displaying warranty-status is preferably performed upon each powering of the product.

The post-sale activation date may be entered by the user. And, the step of permanently recording the post-sale activation date may include the step of manual entry by the user. It is preferred that the post-sale activation date be permanently recorded after a pre-programmed delay with the step of permanently recording the post-sale activation date, including the step of delaying the recording of the post-sale activation date by a pre-programmed delay. Such delay may be about two days and eliminates false settings such that, if batteries are removed during the delay, the saving of the activation date does not occur.

The inventive apparatus is for validating a time-limited warranty of a product warranted by a warrantor. The apparatus includes a product-based controller having a user interface operably connected to the controller. The controller is preferably programmed to permanently record warranty-pertinent information including by recording the post-sale activation date and automatically recording the number of run days since post-sale activation. The product further preferably includes a warranty-pertinent-information retriever. The retriever may be a part of the programmed controller.

In embodiments with the product being configured to record and store images, the permanently-recorded data preferably includes a total number of images recorded by the product. The permanently-recorded data may also include a number of flash images taken and a battery level. The post-sale activation date and the number of run days are preferably recorded in data associated with each stored image.

The following is one example of implementation of the present invention. The user buys a camera and sets (activates) the camera on Dec. 1, 2010 (a recorded post-sale activation date is Dec. 1, 2010). The user uses the camera for thirty days (a recorded number of run days) and then removes batteries until next season. Thirteen months later, batteries are reinstalled but the camera does not work. The camera is out of warranty since the activation occurred more than one year ago. The same would have been true if the camera had been used for 200 days and then “restarted” less than twelve months after the first activation. However, in this example, because the number of run days being so low, the manufacturer may still honor the warranty but would not have to. The number of images would simply demonstrate the validity of the other data.

In an example of a fraudulent warranty claim, the user activates the camera on Dec. 1, 2010, but sets the date as Jul. 1, 2011 (recorded post-sale activation date is Jul. 1, 2011) and starts the camera. On Aug. 1, 2011, the camera fails. The activation date is only thirty days ago, but the number of run days is 270. The number of images is likely to be quite large as well and will demonstrate validity of the run-days data. This camera is out of the warranty period.

The term “run days,” as used herein, means a number of days during which the products was actively used. This excludes days during which the product is stored in inactive condition.

The term “post-sale period,” as used herein, means a length of time in days since a “post-sale activation.”

The term “warranty-pertinent information,” as used herein, means information that includes at least an activation date, which may include a pre-programmed delay, a number of run days, and computations of the period of time since post-sale activation. The warranty-pertinent information may also include additional information characteristic to a particular product. For image-recording cameras, the warranty-pertinent information may include a total number of images taken and a number of images taken with a flash.

### BRIEF DESCRIPTION OF THE DRAWINGS

FIG. 1 is a front perspective view of an exemplary embodiment with a product being a scouting camera.

FIG. 2 is a front elevation view of the scouting camera of FIG. 1.

FIG. 3 is a back perspective view of the scouting camera of FIG. 1.

FIG. 4 is a back elevation view of the scouting camera of FIG. 1.

FIG. 5 is a back elevation view showing a user-interface door removed.

FIG. 6 is a bottom perspective view showing a battery door open.

FIG. 7 is an image taken by the scouting camera and having data embedded into it.

FIG. 8 is a screen shot showing the image of FIG. 7 and the data retrieved from the image.

FIG. 9 is an enlarged view of the data retrieved from the image.

FIG. 10 is a schematic view showing a product connected to a computer for validation of a warranty claim.

### DETAILED DESCRIPTION OF PREFERRED EMBODIMENTS

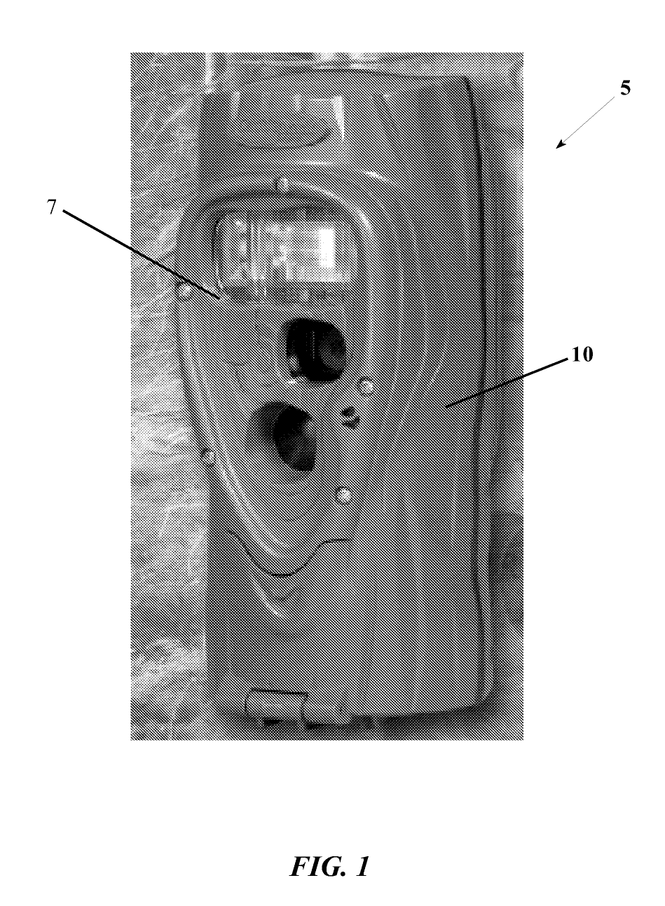

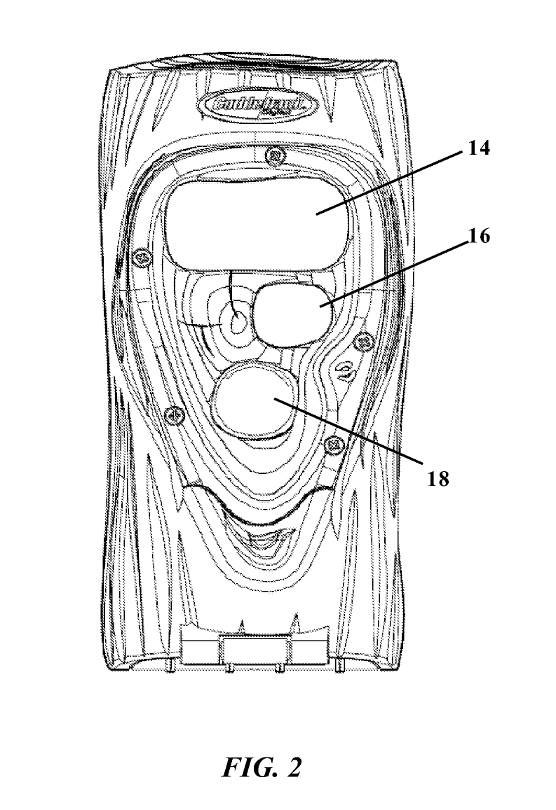

FIGS. 1-10 illustrate an exemplary embodiment of the inventive method and apparatus for validating a time-limited warranty of a product warranted by a warrantor. In the illustrated embodiment, the product is a scouting camera 5 configured to record and store images. Scouting camera 5 has a controller 7 that includes various known system resources such as, for example, a memory device, a processor, and an operating system (not shown specifically but in general) communicating with each other and configured to perform the desired functions of scouting camera 5. FIGS. 1 and 2 best show that scouting camera 5 includes a main body 10 with an illuminator 14, a camera window 16, and a sensor 18 along the front of body 10. Some types of the illuminator may include a conventional visible strobe flash and IR (infrared) LED (light emitting diode) flash. The sensor 18 may be a heat-in-motion sensor.

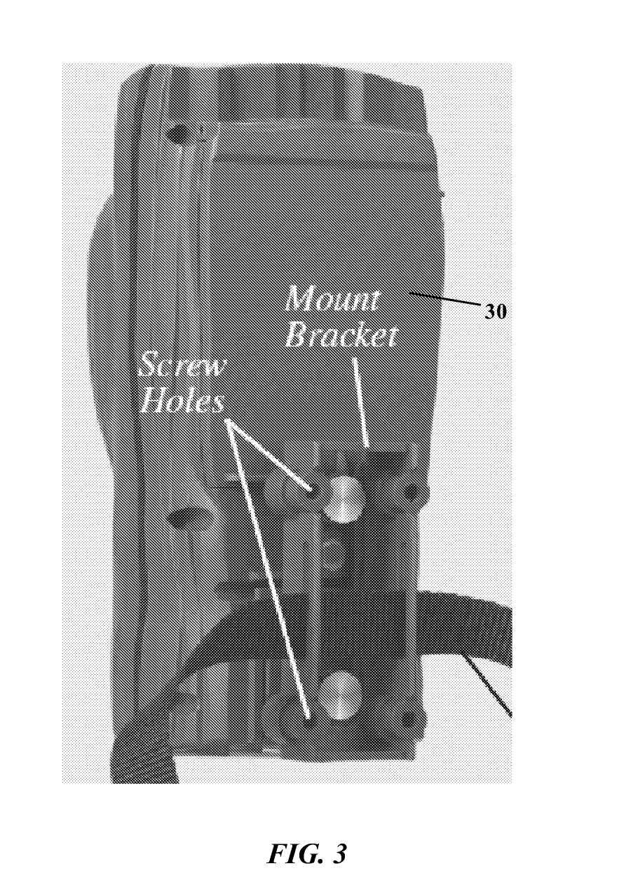

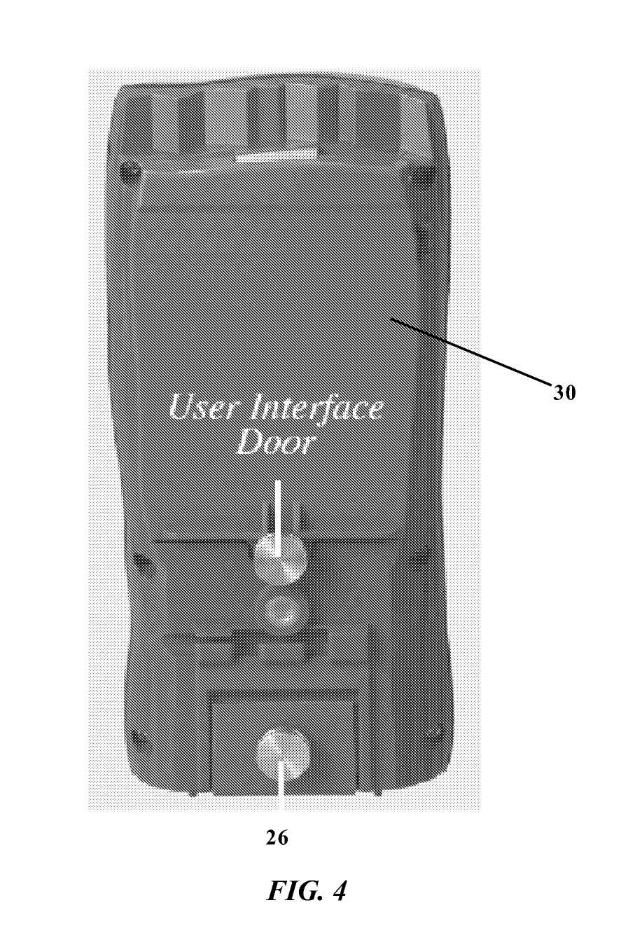

FIGS. 3 and 4 show a user-interface door 30 and a battery door 26 on the back of body 10. When door 30 is in an open position, a user interface 100 is readily accessible to a user.

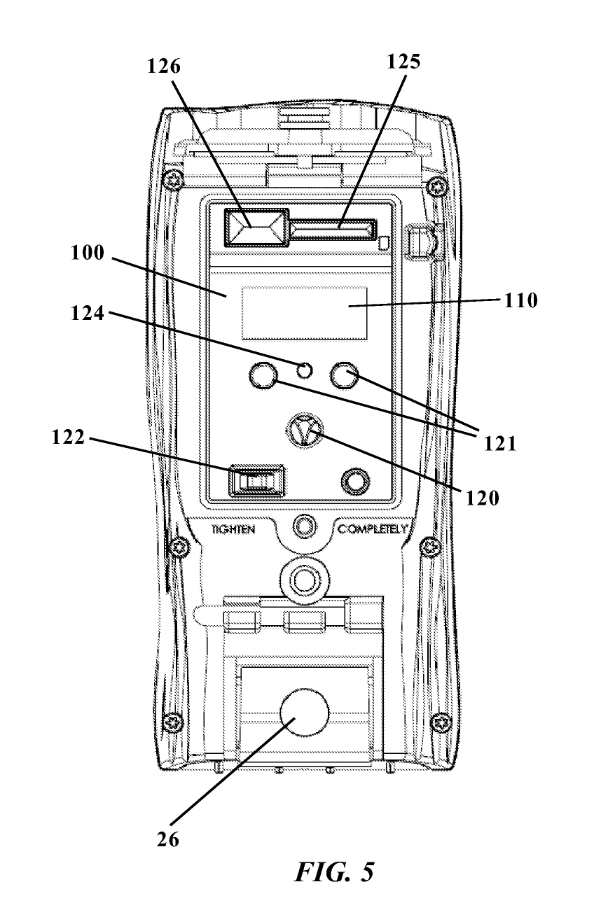

FIG. 5 shows door 30 removed for making necessary settings of camera 5. User interface 100 is configured to perform numerous setup and programming functions by way of few user input devices and by using few steps. User interface 100 is operably connected to controller 7 which is programmed to permanently record warranty-pertinent information including by recording the post-sale activation date and automatically recording the number of run days since post-sale activation.

The post-sale activation date may be set in several ways, including from satellite GPS signals, from the government's ATOMIC clock signals that are broadcasted on radio waves or from Radio & TV signals (via satellite, cable, or over the air).

The post-sale activation date and the number of run days may be recorded in data associated with each stored image. The permanently-recorded data further may include a total number of images recorded by camera 5, a number of flash images taken and a battery level. The post-sale activation date and the number of run days may be recorded in data associated with each stored image.

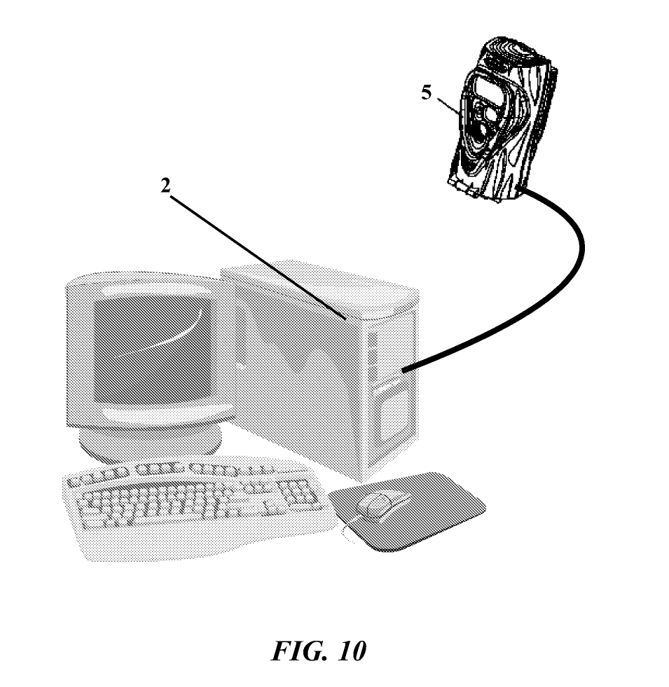

The product may further include a warranty-pertinent-information retriever which may be warrantor-based and being separate from camera 5. FIG. 10 illustrates the retriever as a computer 2 programmed to determine the post-sale period of camera 5, to compare the post-sale period with the length of the time-limited warranty, and to determine whether the recorded number of run days is consistent with the post-sale period. Consistency is preferably determined by the number of run days being no greater than the post-sale period.

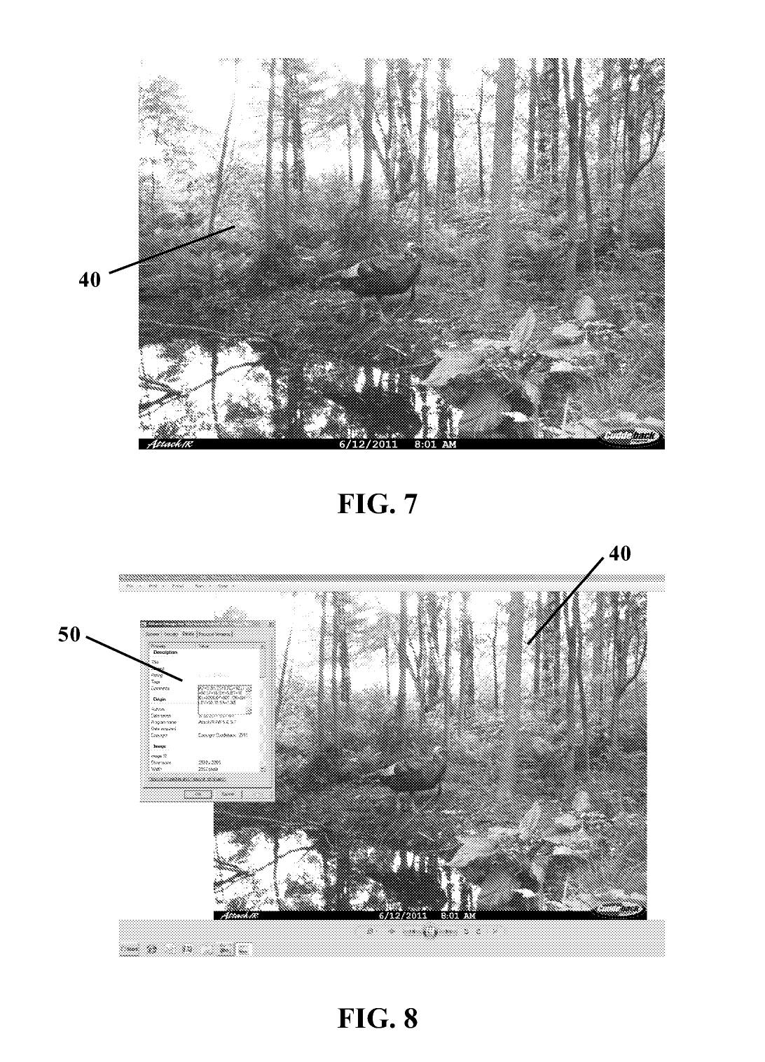

FIGS. 7 shows an image 40 taken by camera 5 with embedded data 50 including warranty-relevant information. Data 50 is retrieved from image 40, as seen on computer screen illustrated in FIG. 8. FIG. 9 best displays data 50 which includes:

### AD=May 31, 2011—Activation Date

### RD=10—Run Days

### LI=80—Lifetime Image Count

### LF=36—Lifetime Flash Image Count

GH=0—Guard Duty Hours (how many hours the camera has been used in time lapse mode)
BT=16—Number of camera was powered on
BL=6006—Battery Voltage, in this case 6.006 volts
BP=90%—Estimated % of battery power remaining
CM=Still—Camera Mode, still image (could also be Guard Duty)
DY=00:15—Camera Delay, in this case 15 seconds
SA=1.30—Image quality

Alternatively, the warranty-pertinent information may be recorded in a camera menu. The menu-stored data may be accessible either only by the manufacturer or by the manufacturer and product user, but is not alterable. The retriever may be a part of programmed controller 7 and include a visual display 110 for showing the warranty-pertinent information.

As seen in FIG. 5, user interface 100 includes visual display 110 which can be an LCD (liquid crystal display) or other suitable known display device that communicates with controller 7 and conveys system status and/or other use-related information, which may include warranty-pertinent data.

User interface 100 shown in FIG. 5 further includes a multiple-stage manually operable switch, such as a rotary switch 120, and a pair of operation keys “A” and “B” 121. Multiple stage rotary switch 120 defines multiple rotational ranges that account for portions of the full rotational range. For example, a SET-range defines a first rotational range for controlling a first category of camera functions, and an ARMED-range defines a second rotational range for controlling a second category of camera functions.

SET-range provides a control mechanism for a clock or calendar feature, allowing controller 7 to, for example, time and date stamp photos when they are taken or allow user to enter the post-sale activation date which is then permanently recorded after a pre-programmed delay. SET-range includes three distinct positions, namely, Time position, Date position, and Year position. ARMED-range provides a control mechanism for picture-taking frequency, by controlling the scouting camera's five dwell times or periods of time that it waits or delays before taking another picture. ARMED-range includes five distinct positions which correspond to dwell times of thirty seconds, one minute, five minutes, fifteen minutes, and thirty minutes. The particular positions, number of positions, and types of camera functions that correspond to such positions are merely exemplary and non-limiting, noting that other camera functions can be controlled by way of multiple-stage rotary switch 120, depending on the particular desired end-use configuration of scouting camera 5. Camera 5 may also be set for a video mode which is enabled by moving a video switch 122 to an “on” position.

A memory card slot 125 communicates with controller 7 and is provided on user interface 100 near a USB connector 126.

FIG. 5 further shows an LED (light emitting diode) 124 provided on user interface 100 and can be configured to indicate feature or other statuses of scouting camera 5, including indicating warranty status. The warranty status may be indicated upon each powering of the product.

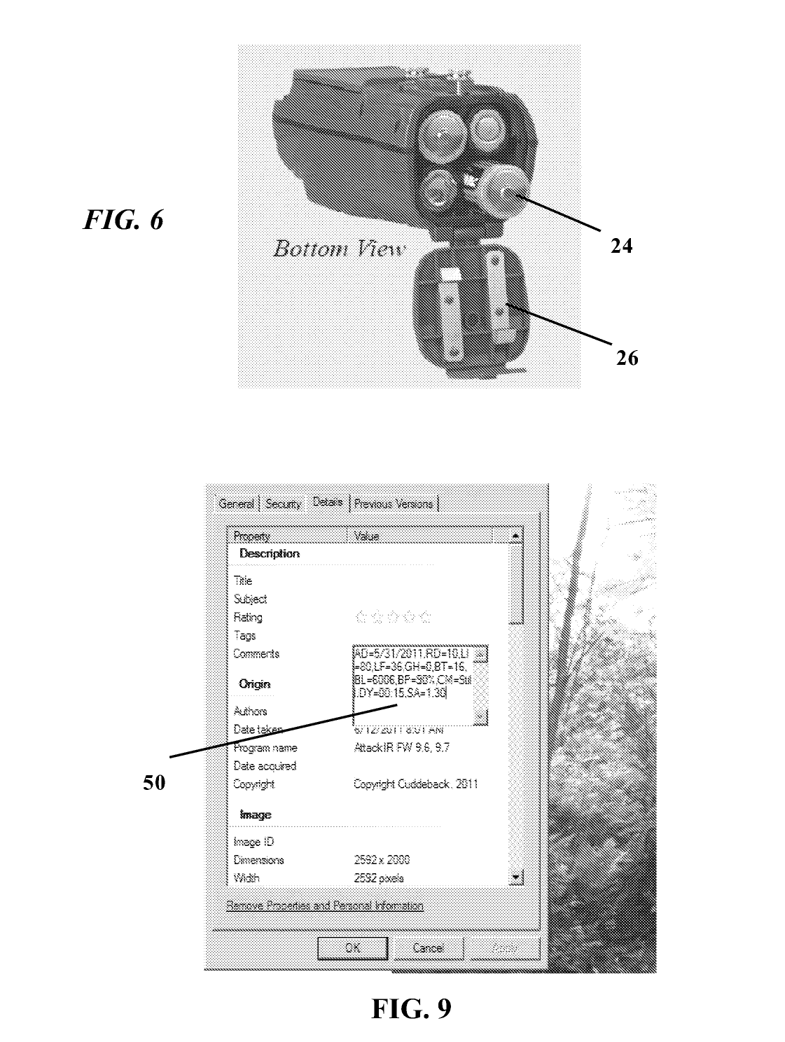

FIG. 6 shows a bottom of camera 5 with a battery door 26 open providing access to a compartment receiving batteries 24 for powering camera 5.

While the principles of the invention have been shown and described in connection with specific embodiments, it is to be understood that such embodiments are by way of example and are not limiting.

1. A method for validating a time-limited warranty of a product warranted by a warrantor, the product having a controller with a user interface operably connected thereto, the method comprising:
permanently recording with the controller warranty-pertinent information including (a) a post-sale activation date and (b) an automatically-counted number of run days since post-sale activation;
retrieving warranty-pertinent information;
comparing the post-sale period with the length of the time-limited warranty; and
determining validity of a warranty claim based on whether the recorded number of run days is consistent with the post-sale period.

2. The method of claim 1 wherein:
the product is configured to record and store images; and
the method further includes the step of permanently recording a total number of images recorded by the product.

3. The method of claim 1 wherein:
the product is configured to record and store images; and
the post-sale activation date and the number of run days are recorded in data associated with each stored image.

4. The method of claim 1 wherein the product is a motion-activated camera.

5. The method of claim 1 wherein the product is a scouting camera for recording the presence of game.

6. The method of claim 1 wherein the product is configured to indicate warranty status.

7. The method of claim 1 wherein the retrieving is performed by the programmed controller.

8. The method of claim 1 wherein the retrieving includes steps taken by the warrantor using a retriever separate from the product.

9. The method of claim 1 wherein the retriever is a computer programmed to perform the steps of determining the post-sale period of the product, comparing the post-sale period with the length of the time-limited warranty and determining whether the recorded number of run days is consistent with the post-sale period.

10. The method of claim 9 wherein consistency is determined by the number of run days being no greater than the post-sale period.

11. The method of claim 1 wherein the step of permanently recording the post-sale activation date includes the step of manual entry by the user.

12. The method of claim 11 wherein the step of permanently recording the post-sale activation date includes the step of delaying the recording of the post-sale activation date by a pre-programmed delay.

13. The method of claim 1 wherein the retrieving step includes a visual display of the warranty-pertinent information.

14. The method of claim 13 further including the step of visually displaying warranty status.

15. The method of claim 14 wherein the step of displaying warranty-status is performed upon each powering of the product.

16. Apparatus for validating a time-limited warranty of a product warranted by a warrantor, the apparatus comprising: a product-based controller having a user interface operably connected to the controller, the controller being programmed to permanently record warranty-pertinent information including by recording the post-sale activation date and automatically recording the number of run days since post-sale activation; and a warranty-pertinent-information retriever.

17. The apparatus of claim 16 wherein:
the product is configured to record and store images; and
the permanently-recorded data further includes a total number of images recorded by the product.

18. The apparatus of claim 16 wherein:
the product is configured to record and store images; and
the post-sale activation date and the number of run days are recorded in data associated with each stored image.

19. The apparatus of claim 16 wherein the product is a motion-activated camera.

20. The apparatus of claim 16 wherein the product is a scouting camera for recording the presence of game.

21. The apparatus of claim 16 wherein the product is configured to indicate warranty status.

22. The apparatus of claim 21 wherein the warranty status is indicated upon each powering of the product.

23. The apparatus of claim 16 wherein the retriever is a part of the programmed controller.

24. The apparatus of claim 16 wherein the retriever is warrantor-based.

25. The apparatus of claim 24 wherein the retriever is a computer programmed to (a) determine the post-sale period of the product, (b) to compare the post-sale period with the length of the time-limited warranty, and (c) to determine whether the recorded number of run days is consistent with the post-sale period.

26. The apparatus of claim 25 wherein consistency is determined by the number of run days being no greater than the post-sale period.

27. The apparatus of claim 16 wherein the retriever includes a visual display of the warranty-pertinent information.

28. The apparatus of claim 16 wherein the post-sale activation date is entered by the user.

29. The apparatus of claim 16 wherein the post-sale activation date is permanently recorded after a pre-programmed delay.
